(19) United States
(12) Patent Application Publication
(10) Pub. No.: US 2024/0171565 A1
(43) Pub. Date: May 23, 2024

(54) HORTICULTURE CLOUD PLATFORM

(71) Applicants: Yen Lam Pham, Santa Ana, CA (US); Stephen J. Scherer, Tustin, CA (US); Eugene U. Knight, Pinon Hills, CA (US)

(72) Inventors: Yen Lam Pham, Santa Ana, CA (US); Stephen J. Scherer, Tustin, CA (US); Eugene U. Knight, Pinon Hills, CA (US)

(21) Appl. No.: 18/377,622

(22) Filed: Oct. 6, 2023

Related U.S. Application Data
(60) Provisional application No. 63/414,338, filed on Oct. 7, 2022.

(51) Int. Cl. H04L 9/40; G06Q 50/02

(52) U.S. Cl. CPC H04L 63/0823; G06Q 50/02

(57) ABSTRACT

An embodiment of a Horticulture Cloud Platform provides for the secure connection of industrial devices to a Cloud platform in the horticulture and agriculture markets. A further embodiment of the Horticulture Cloud Platform provides a process and methodology for the proportional monetization of Cloud access among multiple parties. A further embodiment of a Horticulture Cloud Platform allows manufacturers of hardware devices and products in the horticulture and agriculture Industries, not currently Cloud enabled, to connect to the Cloud in a secure manner, and receive revenue from the benefiting End-User.

### CROSS-REFERENCE TO RELATED APPLICATION

This application claims priority to Provisional Application 63/414,338, filed Oct. 7, 2022, the entire contents of which applications are hereby incorporated by reference.

### BACKGROUND AND SUMMARY OF THE INVENTION

The disclosed invention addresses several challenging and critical issues in the horticulture and agriculture industries and corresponding Internet (Cloud) environments. First, traditional User ID and Password security systems are easily penetrated and breached in today's growing environment. Second, typically Cloud platforms generally do not allow for revenue sharing with other parties in the horticulture and agriculture markets.

An embodiment of the Horticulture Cloud Platform disclosed herein provides for the secure connection of industrial devices to a Cloud platform in the horticulture and agriculture markets.

An embodiment of the Horticulture Cloud Platform provides a process and methodology for the proportional monetization of Cloud access among multiple parties. In essence, it offers a low friction and scalable model for bringing multiple devices together on one platform and operating environment, and then sharing the income derived from this process with multiple contributing parties. In addition, the Horticulture Cloud Platform allows manufacturers of hardware devices and products in the horticulture and agriculture Industries, not currently Cloud enabled, to connect to the Cloud in a secure manner, and receive revenue from the benefiting End-User.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic block diagram illustrating a legacy device with embedded security certificate in accordance with an aspect of the invention.

FIG. 2 is a diagrammatic block diagram illustrating a legacy device connected to a smart connect unit in accordance with an aspect of the invention.

FIG. 3 is a schematic block and flow diagram illustrating an exemplary embodiment of operation of the Horticulture Cloud Platform.

FIG. 4 is a schematic block and flow diagram illustrating an exemplary embodiment of end-user access to the Horticulture Cloud Platform.

### DETAILED DESCRIPTION

Pending commonly owned U.S. patent application Ser. No. 17/526,876, filed Nov. 15, 2021, entitled HORTICULTURE GROWING SYSTEM WITH CONTROL SYSTEM WITH OPTIMIZED PARAMETERS DRIVEN BY CLOUD BASED MACHINE LEARNING, hereinafter referred to as the '876 application, describes an exemplary cloud-based environment, in which local grow systems are connected to the cloud. The entire contents of the '876 application are incorporated herein by this reference.

Embodiments of the invention provide the tools, including Security Certificates, that enable both Manufacturers and Developers to connect Devices to the Cloud platform, sometimes referred to hereinafter as the Horticulture Cloud Platform. The Security Certificates are the key to enabling these industrial devices to securely connect to the Cloud without allowing third parties to hack into the system.

In addition, the disclosed Horticulture Cloud Platform manages the monetization of these Devices, providing revenue sharing opportunities for these Manufacturers and Developers. As end-Users subscribe to the Horticulture Cloud Platform, the Manufacturer and/or Developer will receive their agreed upon portion of the revenue. The Horticulture Cloud Platform will manage the funds collection from the End-User, and then distribute the funds to third parties in an agreed fashion.

The Horticulture Cloud Platform disclosed herein is a portal into the Cloud. It provides a standard front-end to the End-User. The proprietor may also offer the ability for large customers to implement customized front ends via URLs to this platform.

### Definitions

Proprietor: Is the owner or operator of the Horticulture Platform.

Banking Information: Is the specific bank and monetary transfer information necessary to send money to a Manufacturer's, Developer's, Third-Party Partner, of other organization participating in the revenue sharing of End-User subscription fees for use of the Horticulture Cloud Platform.

Banks: Actual financial institutions that a Manufacturer, Developer, Third-Party Partner, or other organization uses to store and manage their financial resources.

Developer: Is an independent third-party company that works with a Manufacturer to enable the product(s) they sell to connect to Horticulture Cloud Platform.

Devices: A device can be either a Legacy Device (sensor, actuators, controller, etc.) that has existed in the horticulture market for a while and cannot currently connect to the Cloud on its own, or it could be a brand new designed and manufactured Device that does not have the ability to connect to the Cloud.

Device Registration: The process of registering a device on the Horticulture Cloud Platform, which includes the verification of the Device Security Certificates, and the recording of the End-User's information and the product purchase information.

End-User: Growers in the horticulture and agriculture markets who purchase a device that they want to connect to the Proprietor's Cloud Platform. The '876 application describes local grow systems which may be the end-user, for example.

Horticulture Cloud Platform Subscription: Is the purchase of a time-based subscription allowing an End-User to access data related to a particular set of devices registered on the Horticulture Cloud Platform, and in some cases actually change the Device's settings and operational parameters in a local grow system.

Cloud Smart Connect Unit: Is a connection device which is configured to provide an interface between an external Legacy Device which provides the necessary Security Certificates, and if necessary, the Cloud interface, such as a network adapter, to enable an external Legacy Device to integrate with the Cloud Back-End Server.

Proprietor's Back-End Server: The Back-End Server on the Cloud is the primary Cloud server for storing, accessing, and viewing data. It also, houses the Product Data Table which tracks products and their owners, as well as the Third-Party Partner Table which provides unique codes and revenue sharing information.

Proprietor's Cloud Platform: A Cloud Platform that connects, manages, operates, and stores data for a variety of horticulture and agriculture products and devices such as controllers, fertigation systems, sensors, fans, etc. of a local grow system; and additionally provides a common platform from which they can be accessed, monitored, and in some cases controlled.

Manufacturer: The manufacturer is a company or entity who has or is currently selling a Device that and End-User desires to connect to the Horticulture Cloud Platform.

Revenue Apportionment Transaction: This transaction calculates the allocation of revenue between proprietor of the platform, the Manufacturer, the Developer (if one exists), and the Third-Party Partner (if one exists) and provides the wire transfer instructions for a Third-Party Payment Gateway to then direct the movement of funds between banks.

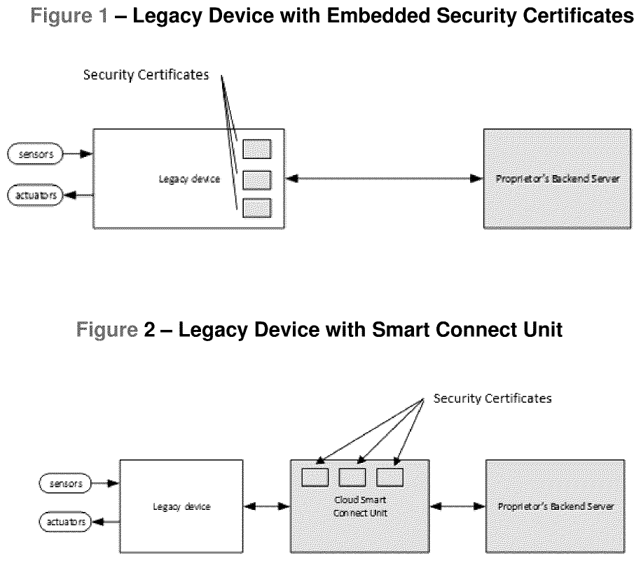

Security Certificates: Security Certificates enable an external device to securely integrate with the proprietor's Cloud Back-End Server and enable the uploading and possible exchange of data from a legacy device. Security certificates can either be embedded directly into the existing firmware of a Legacy Device (see FIG. 1, illustrating a Legacy Device with Embedded Security Certificates), or they can exist in a proprietary Cloud Smart Connect Unit which is assigned to and connected directly to a Legacy Device (see FIG. 2—Legacy Device with Smart Connect Unit), and provides the link necessary for a Legacy Device to connect to the Proprietor's Cloud Back-End.

Security & Monetization Server: Is the Cloud Server that stores and issues the Security Certificates and associated Manufacturer and Developer Banking Information.

Third-Party Partner: Is an organization or entity that sells other company's products/Devices (Manufacturer's Devices), and possibly some of their own, into the horticultural and agriculture markets, that is entitled to receive a portion of the revenue from a Cloud Subscription for the sale of the Device and registering it on the Cloud platform. Examples of a Third-Party Partner could be a Distributor, a Greenhouse Manufacturer, a Rep Organization, a Retailer, and other types of product resellers.

Third-Party Payment Gateway: Is an entity that allows businesses to receive payments online without first setting up their own merchant accounts. Payment gateway organizations allow businesses to entirely bypass the need to own a merchant account.

Transaction Server: Processes transactions taking place when Devices are registered by the End-User on the Horticulture Cloud Platform. The Transaction Server verifies the Device credentials with the Security & Monetization Server. It also accesses the Manufacturer's and Developer's banking information, accesses and verifies the Third-Party Partner's information, and creates the Revenue Apportionment Transaction when Cloud Subscriptions are purchased. Once Device registration is complete and the Cloud platform subscription has been purchased, the Transaction Server processes requests made by the End-User related to the Device and its information. An example of this would be a request for a change in the setpoints of the Device (change in target temperature in the greenhouse, reduction in motor speed of an irrigation pump, reduction in target humidity of the greenhouse, and a increase in irrigation run times).

The respective security and monetization server and back-end server, transaction server may be separate server systems, or may be implemented on one server system. The payment gateway could also be implemented on the horticulture platform. However, in practice it may typically be a third-party gateway so that the proprietor avoids the legal and fiscal requirements associated with payment gateways.

The Process.

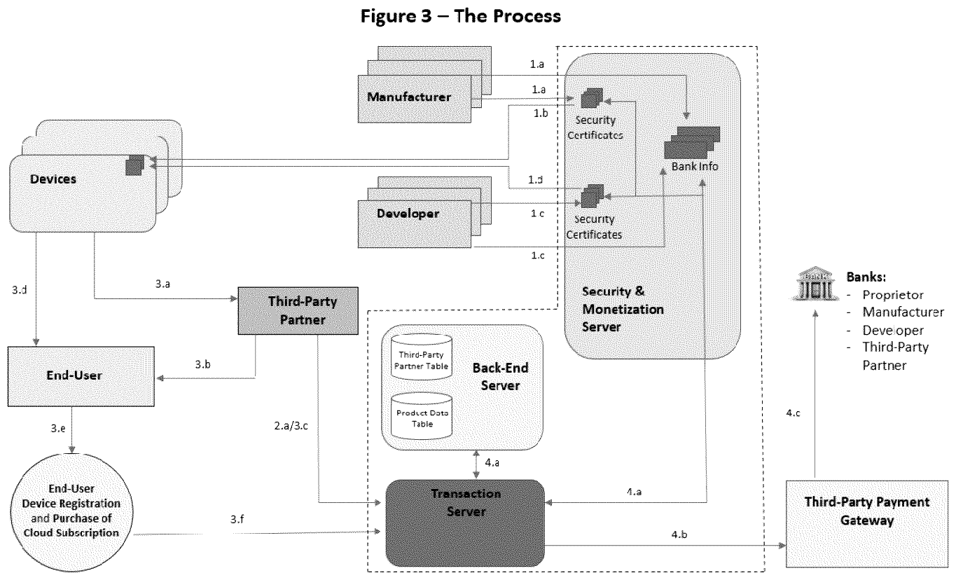

FIG. 3 illustrates an exemplary embodiment of the Horticulture Cloud Platform (enclosed by the dashed line) and an exemplary process of use of the platform.

1. Acquisition of Proprietor's Security Certificates and storing Banking Information.

1.a A Manufacturer, who is currently selling a Device that an End-User desires to connect to the Horticulture Cloud Platform, would access (1.a) the Security & Monetization Server and acquire a Security Certificate. As part of this process the Manufacturer will also provide their Bank Information for later receipts of revenue as part of their portion of the revenue share of the charges for end-user access and utilization of Device data for maintenance and management purposes.

1.b The Manufacturer would then embed (1.b) the Security Certificate (unique to the Manufacturer but not the product) into each one of their developed devices. Each device would have a security certificate identifying who the manufacturer is and what the device is. The security certificate does not identify a particular device in this embodiment, so that the same certificate may be used on many similar devices.

1.c There is an opportunity for an independent Developer to connect a Manufacturer's product to the Horticulture Cloud Platform and share in a portion of the revenue coming from End-User access to the Device on the platform. For example, an independent Developer could contract with a Manufacturer and agree to enable the Manufacturer's Devices (products) to connect to the Horticulture Cloud Platform. The Developer would register (1.c) their organization as a “Developer” and provide their banking information on the Horticulture Cloud Platform.

1.d The Developer would acquire (1.d) a Security Certificate which they would embed into the Manufacturer's product as part of their development work to make the product accessible to the Horticulture Cloud Platform.

2. Third-Party Partner Connection to Horticulture Cloud Platform.

2.a The proprietor may have arrangements with certain Third-Party Partners, typically in the product sales channel of the horticulture and agriculture markets, to sell Devices and related Cloud platform subscriptions to End-Users for the access to the Horticulture Cloud Platform which qualifies them to receive a portion of the revenue derived from an End-User's Cloud Subscription. A Third-Party Partner would register (2.a; 4.a) on proprietor's Back-End Server and be listed in the Third-Party Partners Table.

3. Sale of Device to End-User and Device Registration.

3.a Devices are sold to End-Users and if they are desiring these Devices to be connected to the Horticulture Cloud Platform will register them on the Horticulture Cloud Platform in a variety of ways, resulting in the End-User purchasing a Cloud platform subscription, and the ultimate sharing of revenue between the parties involved. For example, a Third-Party Partner of the Proprietor could purchase a Device with Proprietor's Security Certificates embedded in it.

3.b The proprietor's Third-Party Partner would resell the Device to an End-User.

3.c The Third-Party Partner could register (3.c) the sale of the Device through the Transaction Server, which would record the required Device sale data in the Data Table on the proprietor's Back-End Server.

3.d An alternate approach to the purchase of a Device could be for an End-User to purchase a Device directly from a Manufacturer. For example, an End-user would purchase (3.d) a Device with the necessary proprietor's Security Certificates (from Manufacturer and a Developer) embedded in it.

3.e Once a Device is acquired by an End-User, the Device must be registered on the Horticulture Cloud Platform. For example, after purchasing (3.b) a Device from a proprietor's Third-Party Partner, the End-User would perform the Horticulture Cloud Platform subscription registration process (3.e) while connecting (3.f) the device to the Horticulture Cloud platform. The registration process would cause the Transaction Server to query the Proprietor's Back-End Server and the Proprietor's Security & Monetization Server (4.a) to verify the Security Certificates (one from the Manufacturer and one for the Developer).

3.f In addition, the Transaction Server records the End-User's information, the Device, the Third-Party Partner's information, and the Security Certificate information in the Data Table stored on the Back-End Server.

4. Revenue Collection and Distribution:

4.a Once an End-User registers their Devices on the Horticulture Cloud Platform and purchases their Cloud Platform Subscription, the End-User is able to access the Horticulture Cloud Platform and a Revenue Apportionment Transaction (4.b) is created by the Transaction Server. As part of the calculation of the revenue allocation and the creation of the Revenue Apportionment Transaction, the Transaction Server accesses (4.a) the Back-End Server and the Security & Monetization Server to verify the Device via the Security Certificates, accesses the Manufacturer's and Developers Bank Info, accesses the Third-Party Partner Bank Info (4.b; 4.c), and verifies the allocation agreements or arrangements stored in the Security & Monetization Server.

4.b The Proprietor's Transaction Server takes the data acquired and creates a Revenue Apportionment Transaction with wire transfer instructions and sends this (4.b) to a Third-Party Payment Gateway.

4.c The Third-Party Payment Gateway sends (4.c) wire transfer instructions to the appropriate banks to complete the actual transfer of the funds to the banks of the Manufacturer, Developer, and any Third-Party Partner if applicable.

4.d Manufacturers, Distributors, and Third-Party Partners may receive a portion of revenue per their agreements with the Proprietor of the Horticulture Cloud Platform if the Device is actively connected to the Horticulture Cloud Platform. When a device is no longer actively being used and connected to the Horticulture Cloud Platform by the End-User, revenue sharing and distribution to a Manufacturer, Developer, and or Third-Party Partner will no longer take place.

5. End-User Device and Data Access Via the Horticulture Cloud Platform

5.a After the Horticulture Cloud Platform subscription and registration processes are completed by the End-User, the End-User is now able to access data stored on the Horticulture Cloud Platform, request reports and graphs created from the data stored on the Proprietor's Back-End Server, make changes to the Device configuration if applicable, and perform a variety of other operations available on the Horticulture Cloud Platform.

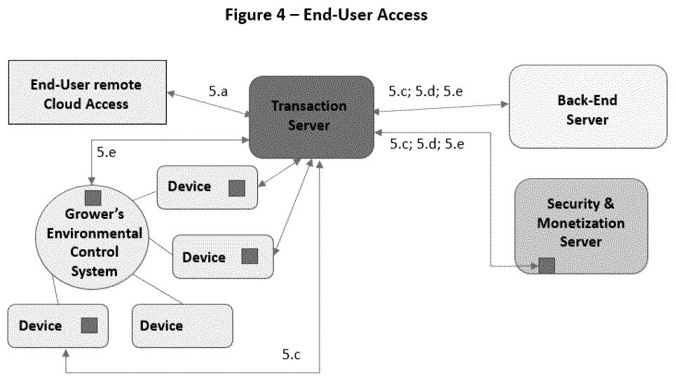

5.b When the End-user attempts to access the device through the Horticulture Cloud Platform, the Transaction Server receives the request from the End-User, then verifies the Security Certificate exists in the Device information in the Security & Monetization Server, and then is granted access to the Device and its information (see FIG. 4).

5.c For example, if a Grower wanted to change the motor speed (setpoint) on an irrigation pump (Device), the Grower through its environmental control system would electronically send the request to the Transaction Server. The Transaction Server would then verify the Security Certificates via a query of the listing on the Security & Monetization Server. Once verification is complete, the Transaction Server would send the requested change in motor speed (setpoint) to the irrigation pump (Device) making the change, and the Transaction Server would then send confirmation of the change back to the Grower.

5.d Another example would be for a Grower through the environmental control system to request a graph of the activity involving a fan (Device) over a specific period of time. Once again, the Transaction Server would verify the Security Certificates via a query of the listing on the Security & Monetization Server. Once verification is complete, the Transaction Server would send the requested report parameters to the Back-End Server, the report would be generated, and then returned to the End-User by the Transaction Server completing the requested transaction.

5.e A third example, would be for a Grower to desire to adjust the target temperature range for the greenhouse during the morning hours. In this case the Grower would not access a particular device itself, but instead access the Grower's Environmental Control System and change the target setpoints for the temperature range. The Transaction Server would then verify the Security Certificates in the Growers Environmental Control System via a query of the listing on the Security & Monetization Server. Once verification is complete, the Transaction Server would send the requested change in temperature range (setpoint) to the Growers Environmental Controller (Device) making the change, and the Transaction Server would then send confirmation of the change back to the Grower.

Although the foregoing has been a description and illustration of specific embodiments of the subject matter, various modifications and changes thereto can be made by persons skilled in the art without departing from the scope and spirit of the invention.

What is claimed is:

1. A connection device which is configured to provide an interface between an external Legacy Device, the connection device configured to provide a Security Certificate, to enable an external Legacy Device to integrate with a Cloud Back-End Server.

2. The connection device of claim 1, further comprising a Cloud interface, such as a network adapter.

3. A Horticulture cloud platform configured to provide a secure connection of industrial devices to the cloud platform in the horticulture and agriculture markets, and wherein the platform is configured to store security certificates required to connect the industrial devices to the cloud platform, and to confirm that each industrial device seeking to connect to the cloud platform has a corresponding security certificate associated therewith which corresponds to a security certificate stored by the platform.

4. A Horticulture cloud platform configured to provide a process and methodology for the proportional monetization of Cloud access among multiple parties, providing an architecture for bringing multiple devices together on one platform and operating environment, and then sharing the income derived from this process with multiple contributing parties.

5. The Horticulture cloud platform of claim 4, further configured to allow manufacturers of hardware devices and products in the horticulture and agriculture Industries, not currently Cloud enabled, to connect to the Cloud in a secure manner, and receive revenue from an End-User.

6. The Horticulture cloud platform of claim 4, comprising:
a security and monetization server;
a transaction server; and
a back-end server configured to maintain and store a product data table and a third party partner table.

7. The Horticulture cloud platform of claim 6, wherein the security and monetization server is configured to store security certificates for devices and banking information for device manufacturers, developers and third party partners of the proprietor of the platform.

8. The Horticulture cloud platform of claim 7, wherein the transaction server is configured to communicate with the security and monetization server and a payment gateway to distribute revenue received from an end-user according to the banking information stored on the security and monetization server to the proprietor of the Horticulture cloud platform, a device manufacturer, a developer and a third-party partner in a prearranged distribution proportion.
